(19) United States
(12) Patent Application Publication
(10) Pub. No.: US 2003/0218306 A1
(43) Pub. Date: Nov. 27, 2003

(54) Juvenile stroller with removable cooler

(76) Inventors: Keith Dixon, Columbus, IN (US); Edmund M. Apperson IV, Columbus, IN (US); Paul T. Zink, Indianapolis, IN (US); Andrew Mendenhall, Indianapolis, IN (US)

Correspondence Address: BARNES & THORNBURG, 11 SOUTH MERIDIAN, INDIANAPOLIS, IN, 46204

(21) Appl. No.: 10/154,553

(22) Filed: May 24, 2002

(51) Int. Cl. B62B 9/12; B62B 9/26

(52) U.S. Cl. 280/47.38

(57) ABSTRACT

A juvenile stroller includes a stroller frame having an armrest. A saddlebag container includes a thermally insulated case and a connector coupled to the armrest to anchor the thermally insulated case to the armrest.

### BACKGROUND AND SUMMARY

The present disclosure relates to juvenile strollers, and particularly to stroller accessories. More particularly, the present disclosure relates to storage units adapted to be carried onboard a Juvenile stroller.

Juvenile strollers are being adapted to carry various child-care and other items in handy onboard locations in addition to carrying infants or other young children. Caregivers appreciate the convenience of being able to store various items onboard the stroller so that those items will be available to the caregiver when the stroller is used to transport a child away from home or vehicle.

According to the present disclosure, a juvenile stroller includes a stroller frame having an armrest and a saddlebag container. The saddlebag container is formed to include a case mount adapted to mount on the armrest and a thermally insulated case coupled to the case mount. This thermally insulated case provides storage to keep items stored therein either cool or warm.

In one illustrative embodiment, a connector is coupled to the armrest. The case mount is wrapped around a top portion of the armrest and coupled to the connector to retain the thermally insulated case in a mounted position alongside the stroller frame and suspended from the armrest.

The saddlebag container is separated easily from the armrest by uncoupling the case mount from the connector on the armrest. The case mount “unfolds” and moves from a curved shape to a flat shape as the case mount is separated from the armrest to provide a carrying handle easily gripped by a caregiver to enhance the portability of the saddlebag container away from the stroller frame.

A left-arm saddlebag container is provided to be coupled to a left armrest and a right-arm saddlebag container is provided to be coupled to a right armrest. When these saddlebag containers are separated from the stroller frame armrests, they can be fastened together to form a single, portable, two-compartment tote bag. The carrying handles of the two saddlebag containers can be mated to provide a carrying handle for the tote bag.

In another illustrative embodiment, the connector comprises a post anchor that is attached to the thermally insulated case. This post anchor is configured to mate with a post on the armrest to retain the thermally insulated case in a mounted position on the armrest.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a juvenile stroller in accordance with a first embodiment of the present disclosure showing a stroller frame, a seat mounted on the stroller frame, and left-arm and right-arm saddlebag containers configured to store items in a thermally insulated cooled or warmed environment, wherein the left-arm saddlebag container is coupled to a left armrest provided by the stroller frame and the right-arm saddlebag container is about to be coupled to a right armrest provided by the stroller frame;

FIG. 2 is a perspective view of the left-arm and right-arm saddlebag containers separated from the stroller frame and oriented to be mated to produce a two-compartment container;

FIG. 3 is an end elevation view of the two-compartment container produced by mating the left-arm saddlebag container to the right-arm saddlebag container;

FIG. 4 is a sectional view taken along line 4-4 of FIG. 1 showing an interior region formed in the right-arm saddlebag container and a bottle stored therein;

FIG. 5 is a perspective view of a juvenile stroller in accordance with a second embodiment of the present disclosure showing a stroller frame, and left-arm and right-arm saddlebag containers configured to store items in a thermally insulated cooled or warmed environment, wherein the left-arm saddlebag container is coupled to the left armrest provided by the stroller frame;

FIG. 6 is a sectional view taken along line 6-6 of FIG. 5 showing a connector mounted on the left armrest and a connector anchor attached to a thermally insulated case included in the left-arm saddlebag container and mated with the connector on the left armrest to retain the thermally insulated case in a mounted position on the armrest and alongside the stroller frame; and

FIG. 7 is a view similar to FIG. 6 showing the connector on the left armrest and the connector and anchor on the thermally insulated case after the left-arm saddlebag container has been separated from the left armrest.

### DETAILED DESCRIPTION OF THE DRAWINGS

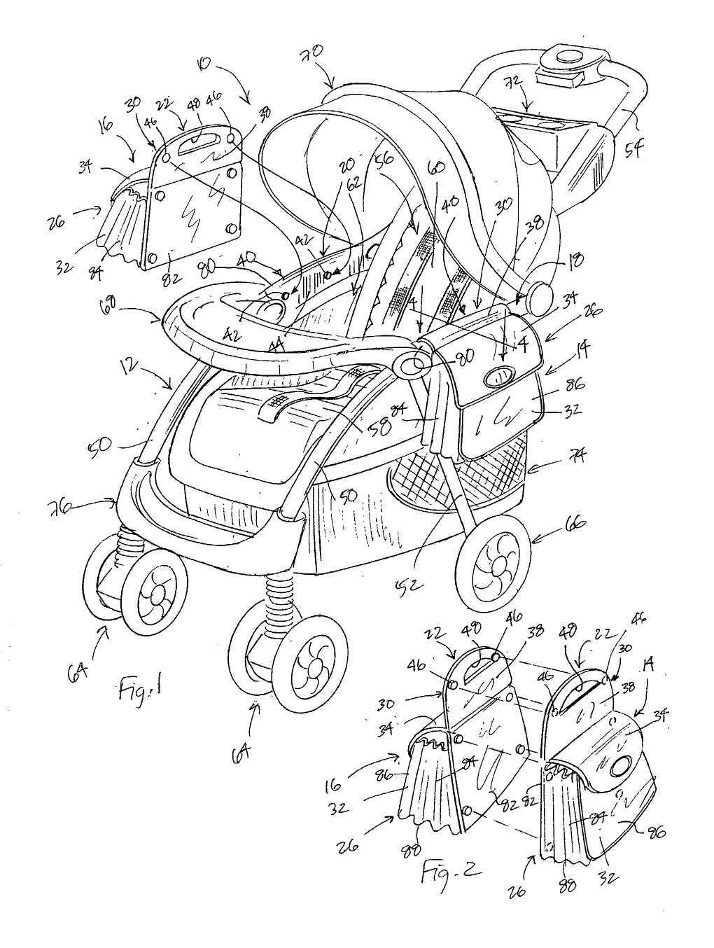

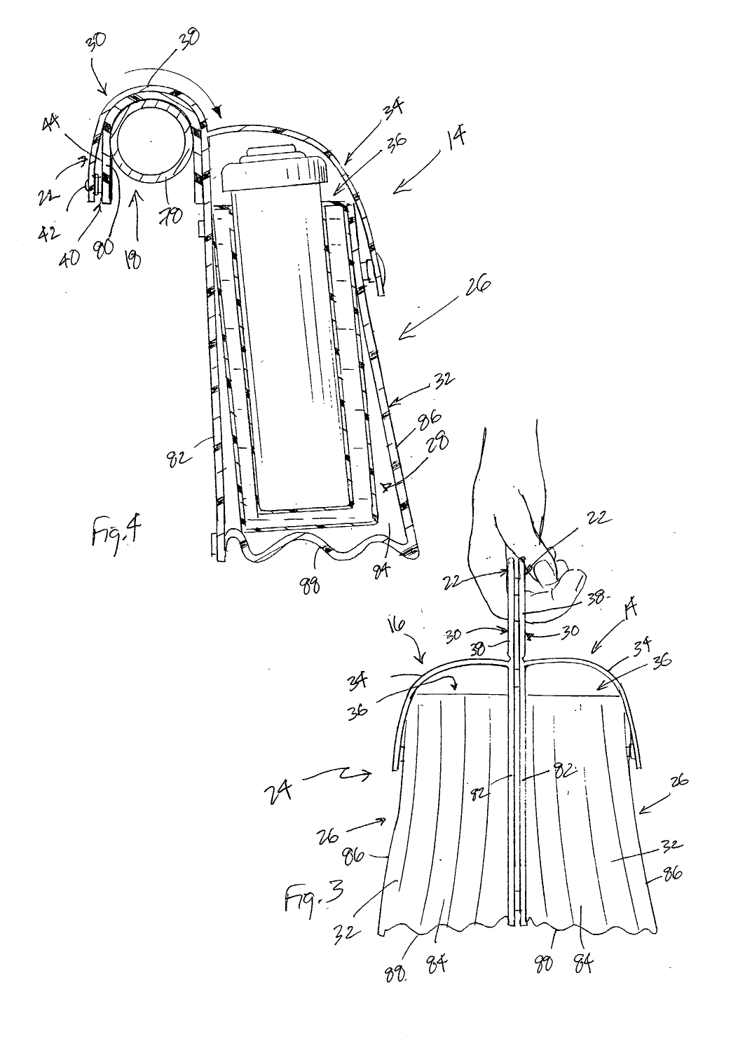

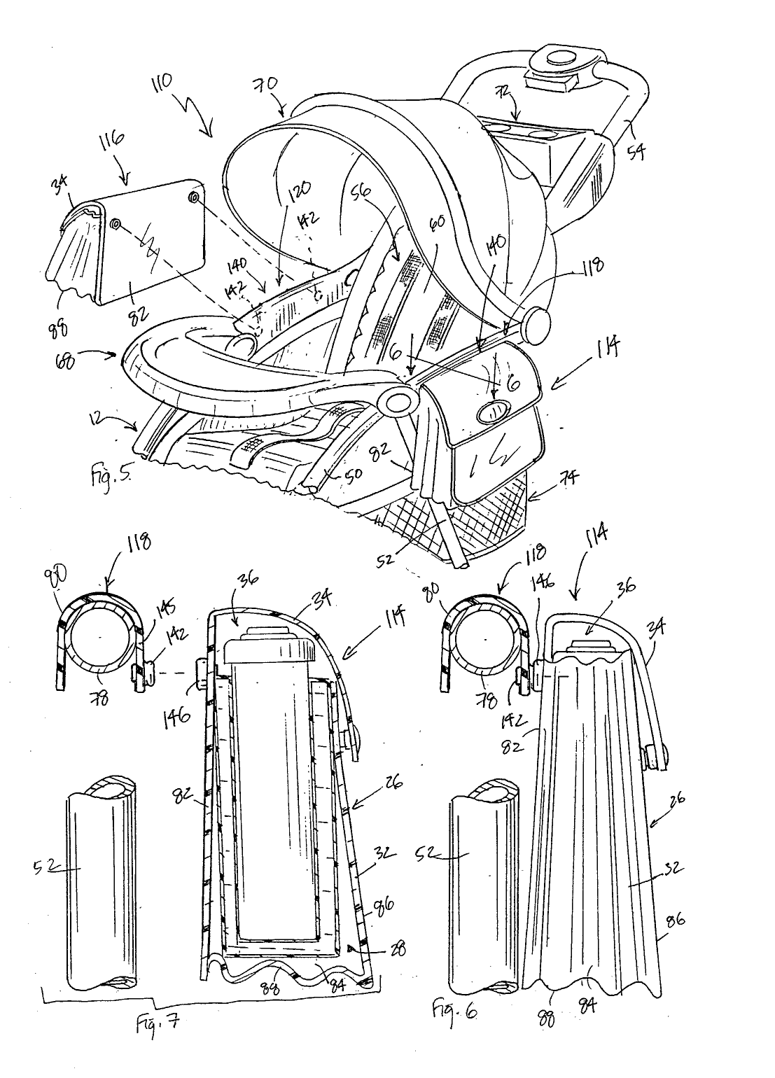

A juvenile stroller 10 includes a stroller frame 12 and a pair of saddlebag containers 14, 16 configured-to store items in a thermally insulated environment as shown, for example, in FIGS. 1 and 4. Each container 14, 16 is coupled to one of the armrests 18, 20 included in stroller frame 12 to move therewith as stroller 10 is pushed by a caregiver. Each container 14, 16 includes a carrying handle 22 to enhance the portability of the container when it is separated from stroller frame 12. Containers 14, 16 can be joined together (in the manner shown in FIG. 2) to produce, for example, a single two-compartment tote bag 24 as shown in FIG. 3. Another saddlebag container mounting design is illustrated in FIGS. 5 to 7.

Each container 14, 16 includes a case 26 formed to include an interior cold storage region 28 therein and a case mount 30 adapted to be mounted on one of the armrests 18, 20 included in stroller frame 12. Case 26 includes a pouch 32 providing interior cold storage region 28 and a pouch cover 34 movable to open and close an opening 36 into interior cold storage region 28 as shown, for example, in FIG. 4. Case mount 30 includes carrying handle 22 and a web of material 38 interconnecting carrying handle 22 and case 26 and being adapted to mate with one of the armrests 18, 20 as shown, for example, in FIGS. 1 and 4.

A connector 40 is coupled to a portion of stroller frame 12 (e.g., each of armrests 18, 20) as suggested, for example, in FIGS. 1 and 4. The case mount 30 of each of saddlebag containers 14, 16 is coupled to one of connectors 40 to retain such container 14, 16 in a mounted position alongside stroller frame 12 and suspended from that designated portion of stroller frame 12. As used herein, if a container 14, 16 is mounted on each armrest, then one of the containers is an “auxiliary” container and the connector associated with the auxiliary container is an “auxiliary” connector.

In the illustrated embodiment, each connector 40 includes a pair of posts 42 coupled to an interior wall 44 of one of armrests 18, 20 and positioned to lie in spaced-apart relation to one another. Each post 42 is arranged to extend from an armrest 18, 20 toward a seat 56 mounted on stroller frame 12 as suggested, for example, in FIG. 1. Each case mount 30 is formed to include (or carries thereon) a post anchor 46 for each of the posts 42 and case mount 30 is adapted to be arranged on an armrest 18, 20 to cause posts 42 to extend into (or otherwise mate with) matching post receivers 46 to retain the associated saddlebag container 14, 16 in the mounted position. It is within the scope of this disclosure to use snaps, buttons, hook-and-loop fasteners, clips, clasps, and other suitable fasteners to provide posts 42 and post anchors 46 so as to anchor case mount 30 to one of armrests 18, 20.

Case mount 30 is made of a pliable sheet of material in the illustrated embodiment so that web of material 38 can be wrapped easily around a designated portion of stroller frame 12 (e.g., an upwardly facing portion of one of armrests 18, 20) as shown, for example, in FIGS. 1 and 4. This pliable sheet of material is thus movable to assume a curved shape when wrapped around one of the armrests 18, 20. This pliable sheet of material is also movable to assume a flat shape when separated from stroller frame 12 so as to facilitate the “marriage” of one saddlebag container 14 to the other saddlebag container 16 upon separation from stroller frame 12 as suggested in FIG. 2 to produce a single tote bag 24 as shown, for example, in FIG. 3.

It is within the scope of this disclosure to provide suitable fastener means on case mounts 30 to couple one case mount 30 to the other case mount 30 when tote bag 24 is created. It is also within the scope of this disclosure to configure the post anchors 46 on container 14 to mate with the post anchors 46 on container 14 to provide means for coupling the carrying handle 22 associated with container 14 to the carrying handle 22 associated with container 16 upon separation of container 14 from left armrest 18 and separation of container 16 from right armrest 20 so that both of the cases 32 are arranged to lie in side-by-side relation. In the embodiment shown in FIGS. 1-4, a finger-receiving aperture 48 is formed in each case mount 30 to define carrying handle 22 so as to facilitate gripping of case mount 30 by a user when the sheet of material is moved to assume a flat shape.

As shown, for example, in FIG. 4, pouch cover 34 is coupled to pouch 32 for movement between closed and opened positions. Pouch 32 and pouch cover 34 cooperate to provide a thermally insulated case in which caregivers can store childcare or other items to be maintained in a cooled environment. This thermally insulated case is adapted to receive an ice pack or any other suitable low-temperature source so as to lower the temperature in interior cold storage region 28 to a selected temperature target or range. The thermally insulated case is also adapted to receive a heat pack or any other suitable high-temperature source so as to raise the temperature in storage region 28 to a selected temperature target or range. Thus, a thermally insulated storage region is provided in case 26 to maintain products stored therein at a desired temperature relative to an ambient temperature outside the storage region for a desired period of time so that cold products stored in the thermally insulated storage region will be maintained at their cold temperature and warm products stored in the thermally insulated storage region will be maintained at their warm temperature.

Referring to FIG. 1, stroller frame 12 further includes front legs 50, rear legs 52, and a push handle 54. A seat 56 including a seat bottom 58 and a seat back 60 is mounted to stroller frame 12 in any suitable manner. In the embodiment illustrated in FIGS. 1-4, armrests 18, 20 are arranged to define a child-receiving space 62 therebetween and to lie above seat bottom 58 and connectors 40 are arranged to lie in that child-receiving space 62. Thus, child-receiving space 62 is bounded in part by armrests 18, 20. It is within the scope of this disclosure to provide a wide variety of seats and frames.

Stroller 10 further includes a set of front wheels 64 coupled to front legs 50 and a set of rear wheels 66 coupled to rear legs 52. A tray 68 and foldable canopy 70 are coupled to stroller frame 12 to cause armrests 18, 20 to lie therebetween. A console tray 72 is coupled to push handle 54 and a storage basket 74 is mounted to lie under seat 56. A footrest 76 is coupled to front legs 50 to lie below seat bottom 58.

As suggested in FIGS. 1 and 4, each armrest 18, 20 includes a tubular member 78 and a shroud 80 having a U-shaped cross section mounted on tubular member 78. Connectors 40 are coupled to interior wall 44 provided on shroud 80.

As suggested in FIGS. 3 and 4, pouch 32 includes a rear wall 82 made of the same sheet of material used to make case mount 30. Pouch 32 further includes a pair of end walls 84, a front wall 86, and a floor 88. Pouch cover 34 has a distal edge coupled to the sheet of material used to form rear wall 82 and case mount 30 at the junction therebetween.

Each saddlebag container 14, 16 can be coupled to one of armrests 18, 20 in the manner suggested in FIGS. 1 and 4. Container 16, for example, can be moved to a location near armrest 20 yet outside of child-receiving space 62, pliable case mount 30 can be wrapped around an upwardly facing portion of armrest 20, and post anchors 46 can be mated with posts 42 included in connector 40. The saddlebag container is now coupled to armrest 20 so as to be retained in a mounted position alongside stroller frame 12 and suspended from the armrest as shown by the arrangement of saddlebag container 14. As suggested in FIGS. 1 and 4, carrying handle 22 of case mount 30 is arranged to lie in an out-of-the-way position in child-receiving space 62 alongside interior, wall 44 of armrest 18 when saddlebag container 14 is retained in its mounted position on armrest 18. If a caregiver desires to separate the saddlebag container from the stroller frame, it is necessary only to unmate post anchors 46 and post 42 and grasp the saddlebag container using the handy carrying handle 22.

A juvenile stroller 110 shown in FIG. 5 is similar to stroller 10 shown in FIG. 1 except that armrests 118, 120 are adapted to include exterior connectors 140 as shown, for example, in FIGS. 5 and 7. A connector 140 is coupled to an outwardly facing exterior portion of stroller frame 12 (e.g. each of armrests 118, 120) as suggested in FIGS. 5-7. Each of the saddlebag containers 114, 116 included in stroller 110 is coupled to one of connectors 140 to retain such container 114, 116 in a mounted position on one of armrests 118, 120.

As shown in FIGS. 5-7, each connector 140 includes a pair of posts 142 coupled to an exterior wall 145 of one of armrests 118, 120 and positioned to lie in spaced-apart relation to one another. Each post 142 is arranged to extend away from seat 56 mounted on stroller frame 12 as suggested, for example, in FIG. 5. Each container 114, 116 includes a post anchor 146 arranged to mate with one of the posts 142 to retain the associated saddlebag container 114, 116 in a mounted position on one of the armrests 118, 120 and alongside stroller frame 12. It is within the scope of this disclosure to use snaps, buttons, hook-and-loop fasteners, clips, clasps, and other suitable fasteners to provide posts 142 and post anchors 146.

1. A juvenile stroller comprising
a stroller frame,
a connector coupled to the stroller frame, and
a container including a case formed to include an interior thermally insulated storage region adapted to receive items to be cooled and a case mount coupled to the case and arranged to wrap around a first portion of the stroller frame, the case mount being coupled to the connector to retain the container in a mounted position alongside the stroller frame and suspended from the first portion of the stroller frame.

2. The juvenile stroller of claim 1, further comprising a seat coupled to the stroller frame and wherein the stroller frame includes an armrest arranged to lie alongside the seat to define the first portion of the stroller frame and the connector is coupled to the armrest and arranged to lie alongside the seat.

3. The juvenile stroller of claim 2, wherein the case mount is formed to include a carrying handle and a web of material interconnecting the carrying handle and the case and the carrying handle is arranged to lie on an inner portion of the armrest facing the seat when the case mount is coupled to the connector and the web of material is wrapped around the first portion of the stroller frame included in the armrest.

4. The juvenile stroller of claim 2, wherein the armrest the connector includes a pair of posts positioned to lie in spaced-apart relation to one another on the armrest and extend toward the seat, the case mount includes a post anchor for each of the posts, and the case mount is arranged on the armrest to cause the posts to mate with the post anchors to retain the container in the mounted position.

5. The juvenile stroller of claim 1, further comprising a tray coupled to the stroller frame and a canopy coupled to the stroller frame and wherein the first portion of the stroller frame is positioned to lie between the tray and the canopy.

6. The juvenile stroller of claim 5, further comprising a seat coupled to the stroller frame, and wherein the seat includes a seat bottom and a seat back and the first portion of the stroller frame lies above the seat bottom.

7. The juvenile stroller of claim 1, wherein the stroller frame is configured to include a child-receiving region bounded in part by the first portion of the stroller frame, the connector is arranged to lie in the child-receiving region, and the case is arranged to lie outside of the child-receiving region.

8. The juvenile stroller of claim 7, wherein the case mount is formed to include a carrying handle and a web of material interconnecting the carrying handle and the case and the carrying handle is positioned to lie in the child-receiving region.

9. The juvenile stroller of claim 1, further comprising a seat coupled to the stroller frame and arranged to lie between the first portion of the stroller frame and a second portion of the stroller frame, an auxiliary connector coupled to the stroller frame, and an auxiliary container coupled to the auxiliary connector.

10. The juvenile stroller of claim 9, wherein the auxiliary container includes a case formed to include an interior thermally insulated storage region adapted to receive items to be cooled and a case mount coupled to the case and arranged to wrap around the second portion of the stroller frame, the case mount of the auxiliary container is coupled to the auxiliary connector to retain the auxiliary container in a mounted position alongside the stroller frame and suspended from the second portion of the stroller frame to cause the first and second portions of the stroller frame and a seat bottom included in the seat to lie in a space between the case of the auxiliary container and the case of the container.

11. The juvenile stroller of claim 9, further comprising means for coupling the container to the auxiliary container to form a single mobile storage unit upon separation of the container from the first portion of the stroller frame and separation of the auxiliary container from the second portion of the stroller frame.

12. The juvenile stroller of claim 1, wherein the case mount is made of a pliable sheet of material that is moved to assume a curved shape when wrapped around the first portion of the stroller frame and that is movable to assume a flat shape when separated from the first portion of the stroller frame.

13. The juvenile stroller of claim 12, wherein the case mount is formed to include a finger-receiving aperture to define a carrying handle in the case mount to facilitate gripping of the case mount by a user when the sheet of material is moved to assume the flat shape.

14. A juvenile stroller comprising
a stroller frame including a left armrest and a right armrest,
a seat coupled to the stroller frame and arranged to lie between the left and right armrests,
a connector coupled to the left armrest,
a connector coupled to the right armrest,
a container mounted on the left armrest and coupled to the connector on the left armrest to be retained in a mounted position alongside the stroller frame, and
an auxiliary container mounted on the right armrest and coupled to the connector on the right armrest to be retained in a mounted position alongside the stroller frame to cause the seat to lie in a position between the container and the auxiliary container.

15. The juvenile stroller of claim 14, wherein each of the container and the auxiliary container includes a case formed to include an interior thermally insulated storage region adapted to receive items to be cooled and a case mount coupled to the case, the case mount of the container is coupled to the connector mounted on the left armrest to suspend the container from the left armrest, and the case mount of the auxiliary container is coupled to the connector mounted on the right armrest to suspend the auxiliary container from the right armrest.

16. The juvenile stroller of claim 15, further comprising means for coupling the container to the auxiliary container to form a single mobile storage unit upon separation of the container from the left armrest and separation of the auxiliary container from the right armrest.

17. The juvenile stroller of claim 15, wherein each case mount is formed to include a carrying handle and further comprising means for coupling the carrying handle associated with the container to the carrying handle associated with the auxiliary container upon separation of the container from the left armrest and separation of the auxiliary container from the right armrest so that both of the cases are arranged to lie in side-by-side relation.

18. The juvenile stroller of claim 17, further comprising means for coupling the case associated with the container to the case associated with the auxiliary handle upon separation of the container from the left armrest and separation of the auxiliary container from the right armrest.

19. A juvenile stroller comprising
a stroller frame including left and right armrests,
a left-arm saddlebag container coupled to the left armrest, and
a right-arm saddlebag container coupled to the right armrest.

20. The juvenile stroller of claim 19, wherein each saddlebag container includes a case comprising a pouch and a pouch cover movable to open and close an opening into an interior region formed in the pouch and a case mount coupled to the case.

21. The juvenile stroller of claim 20, wherein each case mount includes a web of material adapted to engage one of the armrests and means on the web of material for selectively coupling said case mount to said one of the armrests.

22. The juvenile stroller of claim 19, further comprising means for coupling the left-arm and right-arm saddlebag containers together to form a single two-compartment tote bag upon separation of the left-arm saddlebag container from the left armrest and separation of the right-arm saddlebag container from the right armrest.
